(19) United States
(12) Patent Application Publication
(10) Pub. No.: US 2025/0045815 A1
(43) Pub. Date: Feb. 6, 2025

(54) Comprehensive system for facilitating the rental of utility equipment

(71) Applicant: Tyler Ross, Ellington, CT (US)

(72) Inventor: Tyler Ross, Ellington, CT (US)

(21) Appl. No.: 18/230,010

(22) Filed: Aug. 3, 2023

(51) Int. Cl. G06Q 30/0645; G06Q 30/0282; H04W 4/021; H04W 4/029; H04W 4/35

(52) U.S. Cl. CPC G06Q 30/0645; G06Q 30/0282; H04W 4/021; H04W 4/029; H04W 4/35

(57) ABSTRACT

The invention discloses a comprehensive system is claimed for facilitating the rental of utility equipment. The system comprises a user-friendly graphical user interface that enables easy navigation and access to various features by both renters and rentees. Additionally, the system includes a tracking module securely attached to each rental equipment, providing real-time tracking of the equipment's location and monitoring of mileage coverage during transportation. Furthermore, the rental equipment is equipped with a barcode scanner that seamlessly integrates with the system, allowing for swift and accurate retrieval of detailed information specific to each piece of equipment. The system incorporates GPS fencing functionality, which effectively restricts the movement of the rental equipment within a predetermined radius centered around the designated usage location. The graphical user interface, designed to enhance user experience, provides comprehensive information about the rental equipment, including ownership details and rental availability.

### FIELD OF THE INVENTION

The present invention relates generally to the rental service domain, specifically focusing on a platform for sharing utility equipment.

### BACKGROUND OF THE INVENTION

In recent years, the rental market has experienced significant growth and expansion, encompassing various sectors and industries. Within this thriving rental market, there has been a notable increase in interest and activity within the utility equipment rental sector. This surge in demand can be attributed to several factors.

One key driver of this growth is the growing recognition of the advantages and convenience that utility equipment rentals offer. Many companies, both large and small including individuals, have realized the benefits of renting utility equipment instead of outright purchasing it. By opting for rentals, businesses can significantly reduce costs associated with maintenance and depreciation, as they are not burdened with long-term ownership and management responsibilities. This approach allows companies to access the necessary utility equipment for their projects without the financial strain of owning and maintaining the equipment themselves.

Moreover, utility equipment rentals provide an added advantage of easy management through regular inspections. Rental companies ensure that the equipment is well-maintained, regularly serviced, and in optimal condition. This relieves renters from the burden of equipment maintenance and allows them to focus on their core operations.

The increasing interest in the utility equipment rental market has attracted not only established rental companies but also financial institutions. Recognizing the potential profitability and growing demand, these financial entities have ventured into the utility equipment rental market, offering financing options and expanding their service offerings to cater to the needs of businesses and individuals requiring utility equipment.

CN111967936A describes a platform which is a rental service specifically designed for sharing movie and television equipment. It consists of three key components: a human-computer interaction module, a cloud server, and a sharing rental system. The cloud server maintains communication connections with both the human-computer interaction module and the sharing rental system. Within the sharing rental system, there are various modules including a rental information module, a payment module, a cargo delivery module, a use guidance module, and an evaluation module. These modules collectively facilitate the seamless sharing and rental process of movie and television equipment, providing users with a comprehensive and user-friendly experience.

U.S. Pat. No. 10,546,501B2 introduces a system and method designed for tracking rental equipment, specifically focusing on fleet watercraft. The system and method incorporate a communication system and a waterproof, weatherproof GPS tracking device that can be easily affixed to each watercraft. The GPS tracking device seamlessly integrates into the communication system. Additionally, the communication system comprises a client application that operates on a client computing tracking device. The client application is capable of receiving GPS tracking data transmitted by the GPS tracking device. It further processes and interprets the data in various advantageous manners, providing graphical displays of the interpreted data. Overall, this system and method enable efficient tracking of rental equipment, particularly fleet watercraft, utilizing a robust communication system and user-friendly client application.

US20110288891A1 discloses an on-demand platform for renting third-party assets. Within this platform, a self-service system is implemented, enabling third-party renters to electronically submit conditional rental offers (CRO) for specific assets to multiple third-party owners who possess those assets. Moreover, the on-demand platform facilitates the process by receiving asset rental requests, such as for vehicles or other types of assets, and subsequently communicating a range of conditional rental offers from various asset owners. Each owner specifies their individual rental terms within the offers. Additionally, the platform incorporates an asynchronous protocol for the distribution of CROs, further enhancing the efficiency of the rental process.

US20120330696A1 discloses an online platform that enables asset owners and borrowers to coordinate sharing transactions for various assets. The platform ensures that the arranged sharing transactions are covered by insurance and provides online confirmation to both owners and borrowers. Additionally, the completion of these sharing transactions is efficiently managed through the utilization of electronic devices associated with the assets, which provide the necessary information and facilitate the smooth execution of the transactions.

KR102534758B1 discloses an apparatus and method for offering a construction machine rental platform service. In one embodiment of the method for providing this service, a rental request is received from a customer terminal, which includes information regarding the type of construction machine required and the desired rental period. Subsequently, a matching process is conducted to identify a suitable construction machine from a pre-existing list of owned construction machines that match the provided type and rental period information. The selected construction machine is then marked as “rental scheduled” in the machine list, and a rental processing result, including relevant information, is transmitted back to the customer terminal.

Despite the growing demand and interest in the rental market, particularly for utility equipment, there remains a disparity in platform development when compared to the more established household goods rental market. While the household goods rental market has witnessed significant advancements in platform technologies and service offerings, the utility equipment rental sector has not experienced the same level of development.

This discrepancy can be attributed to various factors. Firstly, the utility equipment rental market operates on a relatively smaller scale compared to the household goods rental market. The rental of utility equipment involves specialized machinery and equipment, which are primarily utilized in industrial, construction, and infrastructure projects. Consequently, the demand for these rental services is limited to specific industries and sectors.

Due to the niche nature of the utility equipment rental market, there has been relatively less investment and focus on developing dedicated platforms tailored to its unique needs. Platform development requires substantial resources, including technology infrastructure, software development, and operational logistics. As a result, the development of comprehensive and efficient platforms for utility equipment rentals has been insufficient in comparison to the more established household goods rental market.

However, it is important to note that with the increasing recognition of the benefits and convenience offered by utility equipment rentals, there is a growing realization of the need for improved platform solutions. As the utility equipment rental market continues to expand and evolve, there is a likelihood of increased investment and development of platforms to meet the specific requirements and demands of this sector.

Accordingly, in view of the above-mentioned drawbacks, there is a need for an improved and efficient comprehensive system for facilitating the rental of utility equipment.

### SUMMARY OF THE INVENTION

To address the foregoing problems, in whole or in part, and/or other problems that may have been observed by persons skilled in the art, the present disclosure provides compositions and methods as described by way of example as set forth below.

A principal object of the invention is to provide an improved and efficient comprehensive system for facilitating the rental of utility equipment.

Another object of the invention is to provide an improved comprehensive system which offers a user-friendly graphical user interface that enables easy navigation and access to features for both renters and rentees.

Another object of the invention is to provide an improved comprehensive system that ensures real-time tracking of rental utility equipment.

Another object of the invention is to provide an improved comprehensive system which enables swift and accurate retrieval of detailed information on the rental utility equipment.

Another object of the invention is to enhance the user experience by providing comprehensive information about rental utility equipment, including ownership details and rental availability, through the graphical user interface.

In view of the foregoing, the present invention provides a comprehensive system is claimed for facilitating the rental of utility equipment. The system comprises a user-friendly graphical user interface that enables easy navigation and access to various features by both renters and rentees. Additionally, the system includes a tracking module securely attached to each rental equipment, providing real-time tracking of the equipment's location and monitoring of mileage coverage during transportation. Furthermore, the rental equipment is equipped with a barcode scanner that seamlessly integrates with the system, allowing for swift and accurate retrieval of detailed information specific to each piece of equipment. The system incorporates GPS fencing functionality, which effectively restricts the movement of the rental equipment within a predetermined radius centered around the designated usage location. The graphical user interface, designed to enhance user experience, provides comprehensive information about the rental equipment, including ownership details and rental availability.

In another embodiment, the invention provides a method for facilitating the rental of utility equipment through a comprehensive system. The method includes providing a graphical user interface that allows renters and rentees to navigate through a menu and access various features. It further involves securely attaching a tracking module to each rental equipment to monitor its real-time location and track mileage coverage during transportation. The method also encompasses integrating a barcode scanner into the rental equipment to enable quick and accurate retrieval of detailed information associated with the rental equipment. Moreover, the method includes implementing GPS fencing functionality to restrict the movement of the rental equipment within a predetermined radius from the center of its designated usage location. Additionally, the graphical user interface is configured to display comprehensive information about the rental equipment, including ownership details and rental availability. It also provides a visual representation of the current location of the rental equipment and evaluates its accessibility for potential borrowers at specified times within predetermined locations.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 illustrates a schematic configuration diagram of a comprehensive system for facilitating the rental of utility equipment, in accordance with an embodiment of the present invention;

FIG. 2 illustrates a flowchart of a method for facilitating the rental of utility equipment through a comprehensive system, in accordance with an embodiment of the present invention;

FIG. 3 illustrates a flow diagram of a renter equipment listing process using a renter user interface, in accordance with an embodiment of the present invention;

FIG. 4 illustrates a flow diagram of a rental acceptance process using a renter user interface, in accordance with an embodiment of the present invention;

Skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The invention provides a comprehensive system to facilitate the rental of utility equipment. This system includes a user-friendly graphical user interface that enables easy navigation and access to various features for both renters and rentees. Additionally, each rental equipment is equipped with a tracking module securely attached, enabling real-time tracking of the equipment's location and monitoring of mileage coverage during transportation. Furthermore, the rental equipment is equipped with a barcode scanner that seamlessly integrates with the system, allowing for swift and accurate retrieval of detailed information specific to each piece of equipment. The system also incorporates GPS fencing functionality, effectively restricting the movement of the rental equipment within a predetermined radius centered around the designated usage location. The graphical user interface, designed to enhance the user experience, provides comprehensive information about the rental equipment, including ownership details and rental availability.

The invention introduces a system that revolutionizes the rental of utility equipment by enabling users to conveniently rent equipment from other app users, whether they are nearby or located anywhere in the United States. This innovation not only offers an opportunity for individuals across the country to generate income by renting out their unused or spare equipment but also allows individuals with trucks or trailers to utilize their vehicles for hauling the rented equipment. The system establishes independent contracts between renters and haulers, streamlining and simplifying the entire rental process. The main objective of this invention is to provide a user-friendly platform that simplifies and consolidates the equipment rental process. Users can effortlessly rent equipment, tools, utility vehicles, and recreational vehicles directly from their smartphones, eliminating the need for in-person interactions or leaving the comfort of their homes. The rented equipment is conveniently delivered to the user's doorstep, making the entire rental experience hassle-free and accessible with just a few taps on the smartphone screen.

In an embodiment, the disclosed invention introduces a user-friendly software application that incorporates a GPS Tracker system. When individuals sign up as renters on this platform, they will receive a GPS Tracker device, which is a Global Positioning System (GPS) tracker that uses the GPS to determine the precise location of an object in real time. It becomes the renter's responsibility to ensure that the device is charged before each rental period. This GPS Tracker device plays a crucial role in providing accurate and precise GPS location information of the rented equipment and/or trailer at all times. This information is easily accessible to both the rentee (the individual renting the equipment) and the renter (the individual offering the equipment for rent) through the software application. The GPS tracker can be a commercially available device such as Garmin GPSMAP, Tracki, SpyTec STI GL300 and the like.

Furthermore, the GPS Tracker system implemented in the invention also allows for the tracking of the mileage covered by the rented equipment during transportation. This feature ensures that the movement and usage of the equipment are monitored and recorded, providing valuable information to both the rentee and the renter. Through the software application, users can conveniently access the mileage data and the precise GPS location of the equipment and trailer at all times through a digital map on the application and stay informed about the distance traveled by the equipment during the rental period. This added functionality enhances transparency and accountability in the rental process, benefiting both parties involved.

In an exemplary embodiment, the system incorporates the utilization of Air Tags, such as Apple Air Tags, or RFID tags. These tags are additional components that can be employed within the system to enhance its functionality. By incorporating Air Tags or RFID tags, the system gains the ability to track and locate the rented equipment with even greater precision and accuracy.

The Air Tags, specifically designed by Apple, or RFID tags can be seamlessly integrated into the system, offering an alternative or supplementary method for tracking the equipment's whereabouts. These tags enable the system to provide real-time updates and precise location information, ensuring that both renters and rentees can easily monitor and retrieve the necessary data. Whether it's the exact position of the equipment or its movement history, the inclusion of Air Tags or RFID tags further enhances the system's capabilities, bolstering its overall effectiveness and efficiency in facilitating the rental process.

In an embodiment of the invention, barcode stickers are affixed to the utility equipment, containing detailed specifications such as equipment details, color, condition, and the number of hours it has been used. These barcode stickers serve a crucial purpose during the delivery process. When a delivery driver arrives to pick up the equipment, they can conveniently scan the barcode sticker using a scanning device or a smartphone equipped with a barcode scanning app. This scanning process serves as a confirmation mechanism, ensuring that the driver has the correct equipment that matches the rental order, thus enabling them to initiate the delivery process promptly. The system of the present invention also allows the renter to upload this data on the application so that the rentee shall know all the important details about the equipment before deciding to rent. The information, for example, may contain equipment weight so haulers can make sure they have sufficiently rated hauling equipment (e.g., properly rated trailer and towing equipment classification). In some instances, an RFID tag can be used instead of or in addition to a barcode sticker.

Furthermore, the system records and tracks the data associated with the barcode scanning activity. This feature provides valuable information about when and where each barcode sticker was scanned. By logging this information, the system offers enhanced visibility and transparency throughout the delivery process. This functionality allows both the rentee and the renter to access the scanning data, enabling them to verify the equipment's progress and ensure that it is on track for delivery or return. It enhances accountability and provides an added layer of assurance for all parties involved in the rental transaction.

In an embodiment, the present invention incorporates the use of GPS fencing, a powerful feature that enhances security and prevents unauthorized movement of the rented equipment. This functionality is achieved through the utilization of a GPS tag that is securely attached to the equipment. The GPS fencing feature enables the system to define a predetermined radius centered around the property where the equipment is designated for use.

By implementing GPS fencing, the system effectively restricts the movement of the equipment beyond the predefined radius. If the equipment attempts to leave the fenced area, an alert is triggered and sent to the system administrators. This immediate notification allows for timely action to be taken in case of potential theft or unauthorized relocation of the equipment.

Additionally, the system offers an advanced safeguard by enabling the automatic shutoff or disabling of the equipment if it goes beyond the boundaries of the geo-fencing zone. This additional security measure ensures that the equipment becomes inoperable once it crosses the predetermined perimeter, further preventing any misuse or unauthorized use of the equipment. Through the integration of GPS fencing, the present invention provides robust theft prevention measures, enhances equipment security, and allows for prompt response in case of any unauthorized movement. These features offer peace of mind to both renters and rentees, ensuring that the equipment remains within the designated usage area and reducing the risk of theft or misuse.

In an embodiment, within the software application, an ETA (Estimated Time of Arrival) feature is implemented, leveraging the data obtained from previous company records and GPS tracker and/or airtag information. This feature enables transporters to accurately estimate the arrival time of the rented equipment at its destination. By considering historical data and real-time updates from GPS trackers and/or airtags, the ETA feature provides reliable and timely information to both renters and rentees, ensuring efficient planning and coordination.

In addition to the ETA functionality, the software application incorporates a comprehensive equipment inspection process. Transporters are required to capture and upload pictures of the equipment before and after transportation. This procedure serves as a crucial step to ensure that the equipment is returned in the same condition it was in when it was initially rented. By visually documenting the equipment's condition at both ends of the transportation process, the system promotes transparency, accountability, and effective dispute resolution in the event of any damages or discrepancies.

The inclusion of this equipment inspection feature within the software application enhances the overall rental experience by providing a reliable mechanism to assess and monitor the equipment's condition throughout the rental period. It offers a verifiable record that can be referenced by all parties involved, contributing to a smoother and more trustworthy rental process.

In an embodiment, the disclosed system, a classification framework is implemented to categorize the utility equipment, recreational vehicles and equipment or any other various equipment added to the platform into various types, such as trailers, machinery, earth-moving equipment, or hauling trucks. This categorization allows for efficient organization and streamlined management of the rental inventory. By classifying the equipment, the system ensures that renters can easily browse and locate the specific type of equipment they require for their intended use. Furthermore, the rental pricing structure in the system is based on a day rate. Rentees are charged according to the duration of their rental period, typically measured in days (in some instances, weekly, monthly and seasonal rental rates may apply with a long-term discount). This pricing model provides a straightforward and transparent approach, where renters pay for the number of days they utilize the equipment. It offers flexibility for different rental needs, allowing rentees to choose the rental duration that suits their requirements and budget.

By incorporating equipment classification and day rate pricing, the system simplifies the rental process and enhances user experience. Renters can easily identify the type of equipment they need, while the day rate pricing model provides clarity and fairness in determining the rental costs. This system design allows for efficient equipment utilization and cost-effective rental arrangements for both renters and rentees.

In an embodiment, the system incorporates a real-time communication feature within the software application, enabling users to directly interact with support agents. This functionality aims to enhance and facilitate the equipment rental experience for users. Additionally, the system of the present invention allows renters to get into contact with rentees to iron out any small discrepancies or inconveniences or get in contact with the delivery driver for further information on whereabouts and estimated time of arrival.

Through the software application, users have the ability to engage in real-time conversations with dedicated support agents. This instant communication channel provides a convenient avenue for users to seek assistance, ask questions, or address any concerns they may have during the rental process. Whether it's clarifying rental terms, troubleshooting technical issues, or seeking guidance on equipment selection, the support agents are readily available to provide prompt and personalized assistance.

By offering real-time talk functionality, the system ensures that users receive timely and tailored support, enhancing their overall rental experience. It eliminates the need for users to search for contact information or wait for responses via email or other traditional communication methods. The direct and immediate communication with support agents fosters a sense of trust, reliability, and convenience, creating a positive user experience and facilitating a smooth and efficient rental transaction.

The system allows users to rate their rental experiences, enabling both renters and rentees to receive public ratings based on customer satisfaction. These ratings are prominently displayed under their rental listings, providing valuable feedback to potential users and facilitating informed decision-making. This feature promotes transparency and accountability within the rental community, allowing users to gauge the quality of service and reliability of both renters and rentees based on the collective feedback of previous transactions.

In an embodiment, the system collaborates with multiple external entities to ensure a secure and efficient rental process. Firstly, a trusted third-party background check company is engaged to verify the credibility and reliability of renters and rentees, providing an added layer of assurance for all parties involved. Additionally, a customer service agency is hired to offer dedicated support and assistance throughout the rental experience, addressing inquiries, resolving issues, and ensuring customer satisfaction. Lastly, a reliable third-party payment processor is integrated into the system to facilitate secure and seamless financial transactions between renters and rentees, ensuring the protection of sensitive payment information.

To participate as a renter, individuals must meet certain requirements. They need to be at least 18 years old, possess a valid driver's license, and complete a digital waiver that mitigates our liability. These measures ensure that renters are legally eligible and acknowledge their responsibility when engaging in the rental process.

Within the software application, users are empowered with convenient sorting options for equipment selection. They can easily sort through the available equipment based on size, price, location proximity to their current position, or the specific location where they intend to use the equipment. This functionality allows users to refine their search and quickly identify the most suitable options for their needs. Whether they prioritize equipment size, rental price, equipment type or proximity to their intended location, the sorting feature streamlines the equipment selection process, ensuring users can efficiently find the right equipment that meets their requirements and preferences.

The software application of the disclosed system incorporates a dedicated space within its interface for both renters and rentees to engage in communication with our 24/7 customer service line. Users can easily access this feature through a chat box or by making a phone call, ensuring swift assistance and resolution of any queries or concerns that may arise during the rental process. Additionally, the software application provides a feedback section where all users can provide valuable input, enabling us to continually enhance the quality of the application and improve the overall renting experience. This interactive and user-centric approach fosters direct communication and active participation of customers in shaping the development of the software application, ultimately resulting in an optimized and customer-focused rental journey.

The software application offers categories that classify equipment based on their size and mobility, providing users with clear information on the charges per mile for delivery, which are correlated to the equipment's size and mobility requirements (whether it needs to be trailered or driven to the drop-off location). This categorization allows users to easily sort through the available equipment within their area, enabling efficient browsing and selection of the most suitable options for their specific needs. By presenting this information in a user-friendly manner, the software application enhances the user experience and streamlines the process of finding and renting equipment that aligns with their requirements and preferences.

In an embodiment, the system allows users to browse the app and explore a wide range of potential items available for rent. However, when users decide to proceed with a rental, they are required to sign up for the app, which involves providing specific personal information. This includes the submission of their driver's license, and either social security number or birth certificate. Additionally, users must provide either an active credit card or bank account information.

Upon completing the sign-up process, the rentee will undergo a background check performed by the system. This verification process typically takes one to two business days, during which the system reviews the provided information to ensure compliance with safety and security standards. Once approved, users maintain their approval status indefinitely, unless there are changes or expiration of the submitted information, such as an expired driver's license or outdated credit/banking information. This streamlined approach ensures that users are verified and authorized to continue using the app, promoting trust and safety within the rental community.

By implementing this comprehensive sign-up process and conducting background checks, the system upholds rigorous standards for user verification and approval. This not only enhances security and trust among users but also creates a reliable platform where individuals can confidently engage in rental transactions with peace of mind.

To ensure the integrity of the rental process on the disclosed app, renters are required to follow specific guidelines. These include uploading current pictures and videos showcasing the equipment in proper working condition. Additionally, renters must provide detailed specifications for the equipment, such as the year, make, model, and any important dimensions or load capacity information. Moreover, as part of the verification process, renters must submit a valid driver's license, social security number, and/or birth certificate. To complete the approval process, renters must wait for a period of one to two business days, during which their information and documentation are reviewed by the system. This thorough evaluation ensures that only eligible and trustworthy individuals are permitted to rent through the disclosed app. It is mandatory for all users, whether they are renters or rentees, to create an account and undergo approval procedures managed by the app.

In addition, a deposit is collected from each rentee based on the value of the rented equipment. This deposit serves as a form of security and compensation in the event of damage or breakage during the rental period. If the equipment is returned in a damaged or broken state, the deposit may be used to cover the costs, and the renter may be subject to additional compensation as determined by the app. Renters are responsible for thoroughly documenting the equipment's condition through detailed pictures before and after the rental, as this evidence plays a crucial role in assessing any physical damage that may have occurred (excluding cleanliness issues).

In an embodiment, within the utility vehicle rental system, each vehicle is equipped with a home GPS location. This GPS functionality enables the system to precisely track and identify the specific location of each utility vehicle. The home GPS location serves as a reference point for the system, providing an accurate starting point for the vehicle's availability and facilitating the seamless management of rental transactions. This feature ensures that renters can easily locate and access the utility vehicle they intend to rent, contributing to a smooth and efficient rental experience and to see how far the equipment is from the designated site. It also allows rentees and renters to track and monitor the equipment whereabouts.

In the rental process facilitated by the app, both the renter and rentee reach an agreement regarding the specific duration for which the equipment will be rented and the corresponding rate. This agreement is established through the app, which provides preset rates for reference. By utilizing the app's interface, both parties can easily agree upon the rental duration and the applicable rate, ensuring clarity and mutual understanding. Additionally, rentees can also request extra time for using the equipment and pay for additional rent, wherein specialty rates may apply.

As part of the rental procedure, renters are required to attach a specially designed locked bag to the rented machinery or utility vehicle. This bag, provided by us upon the creation of the account, offers a secure and reliable attachment to the equipment. Additionally, renters are provided with preferably a GPS tracker or alternatively an air tag device such as Apple AirTag which can be either placed inside the or affixed to the bag. In an example, RFID tags can be also attached or placed inside the bag. It is important to note that if the GPS tracker or the AirTag is lost or damaged, the renter assumes responsibility for covering the replacement fee. By attaching the bag and the GPS tracker or the AirTag to the equipment, it allows us, the renter, and the rentee to track the location of the rented equipment. The app's map feature displays the real-time location of the equipment, accessible to the renter, rentee, and us throughout the rental period. This tracking functionality enhances visibility and provides peace of mind for all parties involved, ensuring that the equipment remains traceable and secure during the rental duration.

In an embodiment, in situations where no user has opted for equipment delivery within the disclosed system, a proactive approach is taken to ensure customer satisfaction. The system intervenes by offering a higher incentive for the delivery of the equipment or by contracting a reliable third-party service to efficiently handle the pickup and delivery process. These measures are implemented to guarantee that the equipment reaches its intended destination in a timely and efficient manner.

By providing a higher incentive, the system encourages users to take up the delivery task, creating a win-win situation where both parties benefit. Alternatively, if no user is available or interested in the delivery, the system takes the responsibility of sourcing a third-party service provider with a proven track record in transportation and logistics. This ensures that the delivery is entrusted to professionals who can effectively handle the task, guaranteeing the safe and prompt arrival of the equipment. This proactive approach demonstrates the commitment of the disclosed system to customer satisfaction. By offering increased incentives or arranging third-party delivery, the system ensures that equipment renters receive a reliable and efficient delivery service, even when no user has initially selected the delivery option. This commitment to customer satisfaction enhances the overall rental experience and reinforces the system's reputation for reliability and convenience.

Within the disclosed system, a fee structure is established to ensure a fair exchange between the rentee and the renter. The rentee pays a fee for the duration in which they borrow the equipment, compensating the renter for the temporary use of the equipment. Conversely, the renter collects a fee for the period in which they rent out the equipment to the rentee. This fee arrangement provides a balanced financial transaction that benefits both parties involved in the rental process. The application allows for the collection and disbursement of the rental fee based on the previously set rental rates. To ensure the safe transportation of equipment, the system requires equipment transporters to take pictures at the time of loading and unloading. This documentation serves as visual evidence to verify that the equipment arrives and departs in the same condition. By capturing images at these crucial moments, transporters can provide a reliable record of the equipment's condition, promoting accountability and minimizing disputes.

As part of their responsibility, the delivery person has the important task of double-checking the operation and functionality of the equipment during the loading process. This ensures that the equipment is in proper working order before it is loaded onto the transport vehicle. By conducting this thorough inspection, the delivery person can detect any potential issues and address them promptly, guaranteeing that the equipment is delivered in optimal condition. Owners are responsible for ensuring the equipment maintenance is fully up to date. Penalty fee may apply if rental equipment is not in working order as advertised.

To participate as equipment transporters, individuals are required to create an account on the app. During the account creation process, transporters must provide essential documentation, including an active driver's license and car insurance. These requirements ensure that only qualified and insured individuals are involved in the transportation of equipment, enhancing safety and reliability throughout the process. Transporters must provide specifications on their hauling equipment so the system of the present invention only sends them deliveries that they are capable of completing, for the sake of safety and simplicity.

Regarding payment, equipment transporters are remunerated based on the distance driven while delivering (not to and from the location) and the size of the load being transported. They receive compensation per mile driven, with the specific payment amount varying depending on factors such as the size of the load and the distance traveled. This payment structure ensures fair compensation for transporters based on their efforts and the specific requirements of each transport assignment.

The disclosed system provides various benefits for both renters and owners of equipment. Renters have the opportunity to rent out their unused equipment at lower rates than those typically offered by companies, enabling them to generate extra income to support themselves. They can also rely on delivery contractors who will handle the drop-off and pick-up of the equipment, ensuring a convenient rental experience for both parties involved. The owners of the equipment can also opt in to provide the delivery and retrieval service themselves and receive the compensation. Or choose to do only one of the two, the owner gets first choice. They must submit this information through the app and be accepted by us as a driver. Once renters are signed up and accepted as a driver, they may deliver their own equipment.

Owners have the flexibility to set the rental price for their equipment, provided it falls within the allowed price range based on factors such as equipment type, size, and age. However, the delivery rate is predetermined by the system, ensuring consistency and fairness. The system offers preset rates that align with industry standards, helping owners to set appropriate prices for their equipment rentals.

Renters are responsible for fully fueling the equipment before renting it out. If the rentee has to initially fuel or charge the equipment upon delivery, the fuel cost is deducted from the renter's profit. If the equipment is returned with an empty tank, the deposit will be adjusted on a prorated basis. It is the rentee's responsibility to replenish the fuel or charge the battery if they use or drain it fully during the rental period, except for battery-operated equipment which does not require charging upon return. The Rentee does not have to fuel/charge equipment upon return only if they drain the tank and need more to continue using the equipment. If they opt to refuel the equipment upon return themselves, they will receive their fuel charge back.

In the event that the equipment arrives damaged or is not in working order, the rentee must file a claim through the app. The equipment will be picked up and returned to the renter, and the rentee will receive a credit for the exact rental amount. They will also be allowed to expedite the rental of another piece of equipment, with priority given to their request.

If equipment is returned damaged or not in working order, the fault will be determined based on the evidence presented. Penalties will be imposed accordingly, including potential penalties for owners who falsely advertised their equipment as functional when it was not. Both rentees and renters have the ability to report damages. If a rentee reports self-inflicted damage, they may lose their deposit. Conversely, if a renter claims that their equipment was damaged, the system's team will review the evidence and make a decision regarding the distribution of the deposit and any additional compensation required to fix the equipment.

These provisions within the disclosed system promote fairness, accountability, and a positive rental experience for both renters and owners, ensuring that disputes are resolved in a timely and equitable manner.

The disclosed system implements a set of rules to ensure safe and responsible equipment operation. Only rentees listed on the account with a valid driver's license are authorized to operate the rented machinery. This requirement guarantees that individuals who are qualified and licensed are operating the equipment, prioritizing safety and compliance with legal regulations. To cover the costs associated with facilitating the rental process, the app charges a percentage fee. This fee is deducted from the daily rental rate, ensuring a transparent and seamless payment experience for both the renter and the app's services. By deducting the fee from the rental rate, the app simplifies the financial aspect of the transaction and ensures that all parties involved are compensated accordingly. Additionally, the minimum operating age will be 18 years old for any rented equipment.

A key feature of the software app is its map display, which visually presents all the GPS locations of available rental options within a chosen mile radius. This user-friendly map interface enables users to easily identify and explore nearby rental opportunities. By having a clear overview of the equipment's proximity, users can conveniently evaluate their options and make informed decisions about their rentals. Upon confirming a rental transaction, the app sends a comprehensive confirmation email to both the renter and the rentee. This email includes crucial information such as the day rate (or weekly, monthly or seasonal rate), delivery fee, equipment type, and current condition. To provide visual evidence, the email also includes detailed pictures and thorough descriptions of the equipment. This comprehensive documentation ensures that all parties involved have a complete understanding of the rental agreement and helps maintain transparency and accountability throughout the process.

The versatility of the app is a standout feature, as it allows users to rent out a wide range of unused equipment. From trucks, trailers, and tractors to power equipment, golf cars, recreational vehicles, any sporting vehicles or equipment and even RVs, the app accommodates diverse rental needs. This broad selection of equipment options ensures that users can effectively monetize their unused assets while providing a comprehensive range of choices for those in need of specific equipment.

Furthermore, to assist rentees in finding suitable rentals, the app provides a user-friendly map within the application. This map displays all available rental options in the rentee's local area. The app offers convenient filtering options, allowing rentees to refine their search based on price, desired rental duration, and distance. Additionally, the app provides an estimated delivery fee based on the distance and size of the equipment, giving rentees an understanding of the associated costs. These features empower rentees to make informed decisions about their rentals, considering both affordability and convenience. Rentee's can also opt to pick up the equipment themselves if they have the qualifying credentials and hauling equipment depending on the size and specifications of the equipment they are renting. They must submit this information through the app and be accepted by us as a driver. Once a rentee is signed up and accepted as a driver they may pick up their own rentals.

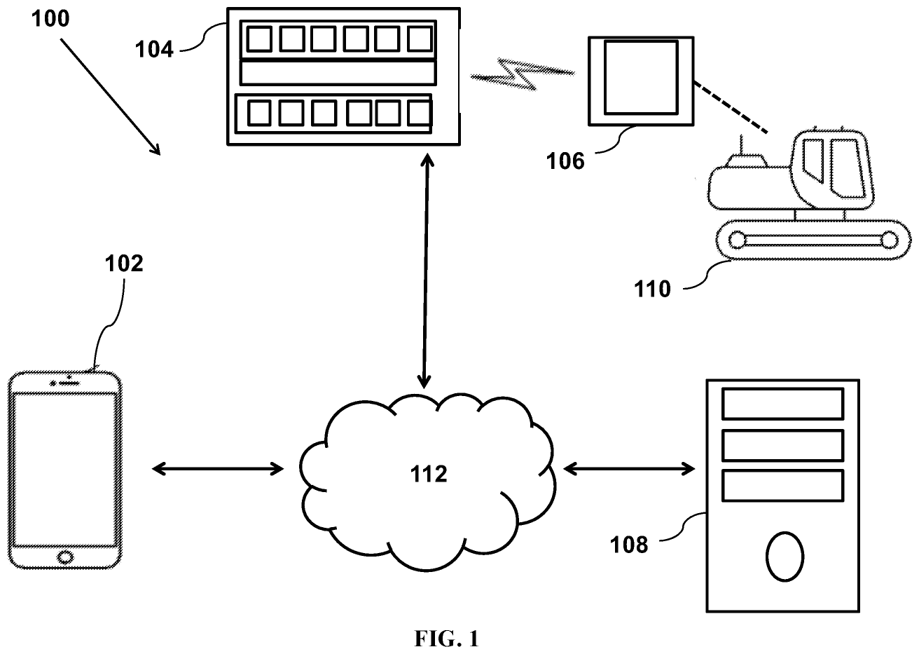

In accordance with an embodiment of the present invention, FIG. 1 illustrates a schematic configuration diagram of a comprehensive system for facilitating the rental of utility equipment. The disclosed system for enabling the rental of utility equipment, as described in the current application, comprises a utility equipment rental platform service provider (referred to as ‘service providing device 108’ herein). This service provider includes a customer terminal 102, a database 104, and a sensor module 106, all integrated to facilitate the rental process for utility equipment.

The service-providing device 108, customer terminal 102, database 104, and sensor module 106 are capable of seamless communication with each other via the network 112. The network 112 refers to a connectivity structure that facilitates the exchange of information between various nodes, such as terminals and servers. Examples of such a network include 3rd Generation Partnership Project (3GPP) network, Long Term Evolution (LTE) network, 5G network, WIMAX (World Interoperability for Microwave Access) network, Internet, LAN (Local Area Network), Wireless LAN (Wireless Local Area Network), WAN (Wide Area Network), PAN (Personal Area Network), wifi network, Bluetooth network, satellite broadcasting network, analog broadcasting network, DMB (Digital Multimedia Broadcasting) network, and more. It is important to note that these examples are not exhaustive, and other communication networks may also be included in the network 112.

The customer terminal 102 encompasses a variety of wireless communication devices, such as smartphones, Ipads, tablets and PCs, and more. It may also include user terminals compatible with various communication systems like PCS (Personal Communication System), GSM (Global System for Mobile communication), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet). In essence, the customer terminal 102 caters to all types of wireless devices utilized for communication purposes.

As outlined in the embodiment of the current application, the database 104 comprises a diverse array of data pertaining to each utility equipment available for rent through the disclosed platform. This data includes identification details, status information, and historical records associated with the equipment. The database serves as a storage system containing a categorized list of utility equipment, and it is regularly updated with the rental status of each item. This ensures efficient matching of utility equipment with specific rental requests as they arise.

Furthermore, as described in the embodiment of the current application, the sensor module 106 is affixed to each utility equipment rented through the disclosed rental platform. This sensor module serves as a device for acquiring measurement data about the equipment whereabouts, distance traveled, home location, current location, the operational condition of the construction machine, and maintenance time. It is capable of transmitting the collected measurement data to the service-providing device 108, where the data is utilized to estimate the expected maintenance time for the equipment.

Hereinafter, specific functions, and operations of the service-providing device 108 will be described.

The service-providing device 108 has the capability to receive rental requests, which consist of utility equipment type information and rental period details, from the customer terminal 102. As previously described in the embodiment of the current application, utility equipment can be categorized into various types, as elaborated in earlier sections. Moreover, the service-providing device 108 is capable of conducting a matching process by comparing the utility equipment type information and rental period details in the received rental request with the list of previously rented utility equipment. This matching procedure ensures the identification of a suitable utility equipment that aligns with the specific requirements of the rental request.

More precisely, the service-providing device 108 can choose the appropriate utility equipment from a range of potential candidates, taking into account both the expected maintenance time and the estimated return time for each of these candidates listed in the database 104. To accomplish this, the database 104 contains essential return information for each candidate utility equipment, outlining predetermined rental schedules and expected maintenance intervals, which are determined based on factors like the rental period, rental frequency, and equipment age. This data is analyzed to allocate suitable utility equipment, ensuring an optimal match for the rental request. With regard to longer duration rentals, the system of the present invention allows to include the maintenance requirements into the longer term rental agreements, wherein rentees will have to pay for and complete the maintenance required on the seasonal and longer rentals, with the cost being deducted from their rental price.

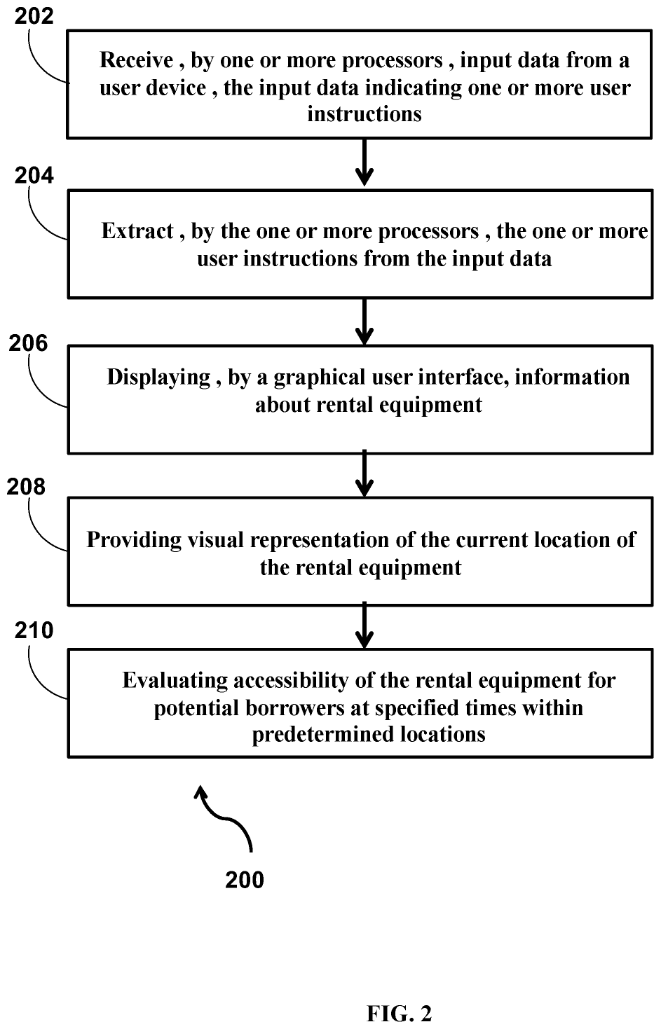

In accordance with an embodiment of the present invention, FIG. 2 illustrates flowchart of a method 200 for facilitating the rental of utility equipment through a comprehensive system. This method involves a sequence of steps executed by one or more processors to streamline the rental process. Initially, the method starts by receiving 202 input data from a user device, wherein the input data consists of one or more user instructions. These instructions are crucial for the subsequent stages of the rental process. Further, one or more processors extract 204 the user instructions from the received input data. These extracted instructions serve as the basis for the system to proceed with the rental transaction. The method then progresses to display 206 the relevant information about the available rental equipment through a graphical user interface. This interface provides users with a comprehensive view of the equipment options, specifications, and availability, simplifying their decision-making process.

Further, in addition to displaying equipment information, the method also offers a visual representation 208 of the current location of the rental equipment. By providing this real-time map display, potential borrowers can easily identify the equipment's precise location, allowing them to assess the convenience of renting it within predetermined locations. Lastly, the method evaluates 210 the accessibility of the rental equipment for potential borrowers. This evaluation is carried out to determine whether the equipment is available for rental at specified times and within the predefined locations. This step helps ensure that the rental process is efficient and allows users to find equipment that aligns with their specific needs and scheduling requirements.

In conclusion, the illustrated flowchart outlines a method that utilizes user instructions, graphical user interface, and a real-time map display to facilitate the rental of utility equipment through a comprehensive system. By following these steps, the system provides users with valuable information and simplifies the process of finding and renting equipment, enhancing the overall rental experience.

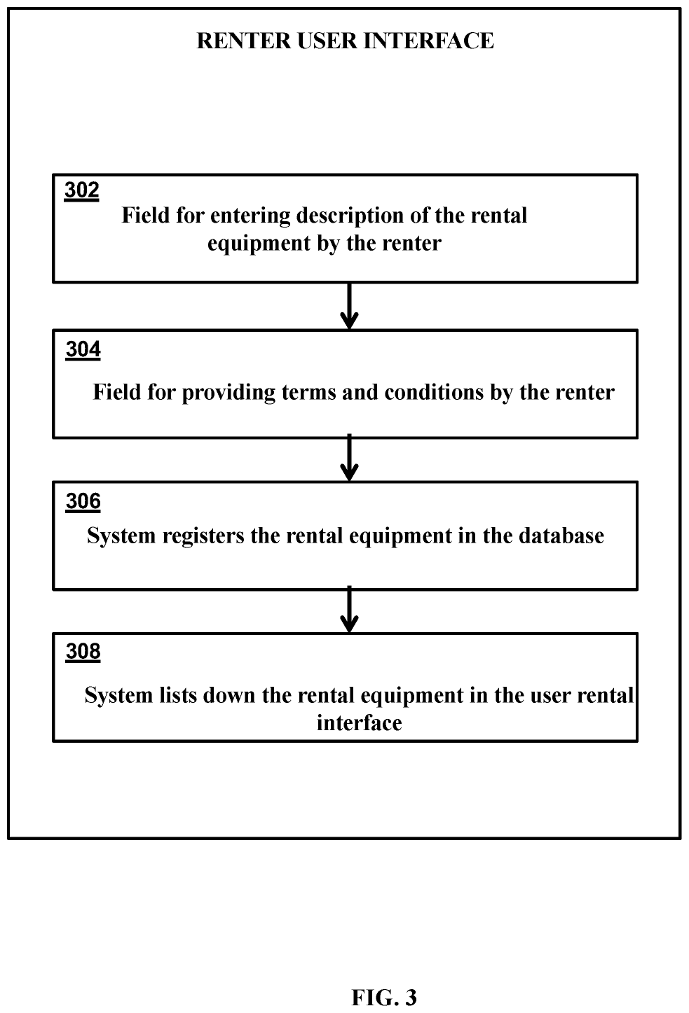

In an embodiment of the present invention, FIG. 3 illustrates a flow diagram of a renter equipment listing process using a renter user interface. The process of listing rental equipment by the renters is carried out through one or more renter user interfaces, following the steps described in FIG. 3. Initially, at stage 302, the renter provides a description of the rental equipment. Subsequently, at stage 304, the renter furnishes additional rental terms, which may include equipment availability schedules, asset location, rental price, driver rating requirements, and other relevant information. The system then proceeds to register the equipment in the equipment renter's database at stage 306. Consequently, at stage 308, the renter's equipment is displayed and made accessible through the renter user interface.

In certain embodiments, the renter's equipment is showcased in the renter interface within a user-friendly smartphone or computer application, specifically designed for the on-demand third-party asset platform. Alternatively, in other embodiments, the renter's asset is presented in the renter interface within a web page, catering to a web-based service for the disclosed system.

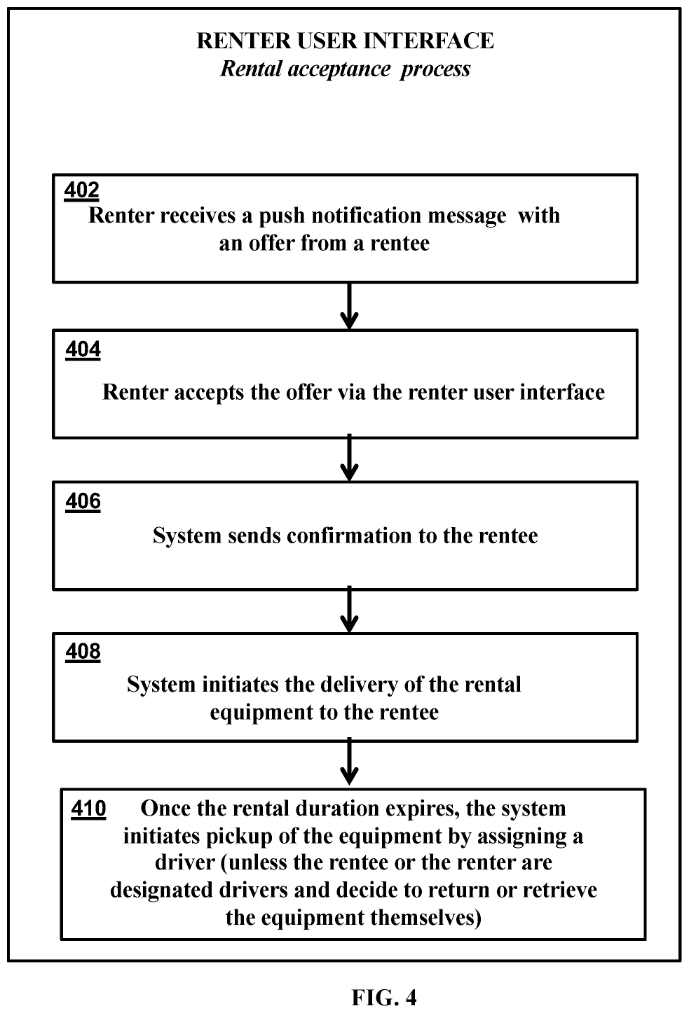

In an embodiment of the present invention, FIG. 4 illustrates a flow diagram of a rental acceptance process using a renter user interface. The process of accepting a rental request through the rental user interface is facilitated via one or more renter user interfaces, involving several sequential steps. First, at step 402, the renter receives a push notification message containing an offer from a prospective rentee. Subsequently, at step 404, the renter proceeds to accept the offer by utilizing the renter user interface. Upon acceptance, at step 406, a confirmation is sent to the rentee, confirming the successful rental transaction. At step 408, the process of delivering the rental equipment to the rentee is initiated, ensuring a seamless and efficient rental experience for both parties involved. And finally at step 410, once the rental duration expires, the system initiates pickup of the equipment by assigning a driver, unless the rentee or the renter are designated drivers and decide to return or retrieve the equipment themselves. In summary, the process begins with the renter receiving a rental offer notification, followed by the renter's acceptance through the renter user interface. Once accepted, a confirmation is sent to the rentee, and the rental equipment delivery process is promptly initiated, enabling a smooth and timely rental process for all participants.

Terms and phrases used in this document, and variations thereof, unless otherwise expressly stated, should be construed as open-ended as opposed to limiting. As examples of the foregoing: the term “including” should be read as mean “including, without limitation” or the like; the term “example” is used to provide exemplary instances of the item in the discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art. Although the foregoing subject matter has been described in some detail by way of illustration and example for purposes of clarity of understanding, it will be understood by those skilled in the art that certain changes and modifications can be practiced within the scope of the appended claims.

What is claimed is:

1. A comprehensive system for facilitating the rental of utility equipment, the system comprising:
a graphical user interface that enables both renters and rentees to navigate through a menu and access various features;
a tracking module for tracking real-time location and mileage coverage of the rental equipment during transport; the tracking module is operatively connected to a GPS tracking device securely attached to each rental equipment;
a barcode or RFID scanning module for quick and accurate retrieval of detailed information pertaining to the rental equipment from a barcode sticker or RFID tag securely attached to each rental equipment; and
a GPS fencing module that restricts the movement of the rental equipment within a predetermined radius from the center of its designated usage location, wherein the graphical user interface is further configured to:
i. display comprehensive information about the rental equipment, including ownership details and rental availability;
ii. provide a visual representation of the current location of the rental equipment, and
iii. evaluate the accessibility of the rental equipment for potential borrowers at specified times within predetermined locations.

2. The system of claim 1 further includes an alert module designed to promptly notify either the renter or the rentee or both in the event that the rental equipment is detected outside the defined GPS fencing boundaries.

3. The system of claim 2, wherein the rental equipment is equipped with an automatic shutdown or disablement feature that activates upon breaching the GPS fencing.

4. The system of claim 1 further includes a classifier to classify the rental equipment into predetermined categories.

5. The system of claim 1 further includes a receiving unit for receiving a request from the renter which includes information specifying the type of rental equipment and desired rental period.

6. The system of claim 5 comprises a matching unit that compares the type of rental equipment information and rental period information provided in the rental request with a list of available rental equipment and identifies a target rental equipment that matches the specified criteria.

7. The system of claim 1, wherein before approving the renter or the rentee, the system runs a background check of the renter and the rentee based on the stored information.

8. The system of claim 1, wherein the system includes details of a transporter that transports the rental equipment from the renter to the rentee of the rental equipment.

9. The system of claim 1, wherein the rentees are shown a map in the graphical user interface which displays all of the currently available rentals in their area.

10. The system of claim 1 further includes a provision that enables users to rate their rental experience.

11. The system of claim 10, wherein the system features a rental listing that includes a public rating for both the renter and the rentee.

12. The system of claim 1, wherein the system enables users to sort through available rental equipment based on parameters comprising size, price, proximity to their location, equipment features, and a specific location of intended use of the rental equipment.

13. The system as claimed in claim 1, comprises a designated section that allows both the renter and the rentee to engage in real-time communication with a 24/7 customer service line, accessible via chat box or phone call.

14. The system of claim 1, wherein the rental equipment is equipped with a home GPS location feature, enabling the equipment to be assigned a designated, predefined location for easy tracking and management during the rental period.

15. The system of claim 1, wherein the tracking module attached to the rental equipment enables continuous monitoring and tracking of the equipment's location.

16. The system of claim 1, wherein the system requires a rental equipment transporter to create an account on the system using valid identification documents.

17. The system of claim 1, wherein the system allows renters the flexibility to set the rental price for their equipment, while the delivery rate of the rental equipment is determined by the system which arranges for the rental equipment to be collected and returned to the renter.

18. The system of claim 1, wherein if the rental equipment arrives in a damaged or nonfunctional state, the rentee has an option to initiate a claim through the system.

19. A method for facilitating the rental of utility equipment through a comprehensive system, comprising the steps of:
a. providing a graphical user interface that enables renters and rentees to navigate through a menu and access various features;
b. securely attaching a GPS tracking device to each rental equipment to monitor its real-time location and track mileage coverage during transportation;
c. integrating a barcode sticker or RFID tag into the rental equipment to facilitate quick and accurate retrieval of detailed information associated with the rental equipment;
d. implementing GPS fencing functionality to restrict the movement of the rental equipment within a predetermined radius from the center of its designated usage location, wherein the graphical user interface is further configured to:
i. display comprehensive information about the rental equipment, including ownership details and rental availability;
ii. provide a visual representation of the current location of the rental equipment; and
iii. evaluate the accessibility of the rental equipment for potential borrowers at specified times within predetermined locations.

20. A computer program product, the computer program product being embodied in computer readable storage medium and comprising computer instructions for:
a. providing a graphical user interface that enables renters and rentees to navigate through a menu and access various features;
b. securely attaching a GPS tracking device to each rental equipment to monitor its real-time location and track mileage coverage during transportation;
c. integrating a barcode sticker or RFID tag into the rental equipment to facilitate quick and accurate retrieval of detailed information associated with the rental equipment;
d. providing a barcode or RFID tag reader application configured to scan and read a barcode or RFID tag; and
e. implementing GPS fencing functionality to restrict the movement of the rental equipment within a predetermined radius from the center of its designated usage location.
